(19) United States
(12) Patent Application Publication
(10) Pub. No.: US 2014/0282283 A1
(43) Pub. Date: Sep. 18, 2014

(54) Semantic Gesture Processing Device and Method Providing Novel User Interface Experience

(71) Applicant: Caesar Ian Glebocki, Chicago, IL (US)

(72) Inventor: Caesar Ian Glebocki, Chicago, IL (US)

(21) Appl. No.: 14/214,718

(22) Filed: Mar. 15, 2014

Related U.S. Application Data
(60) Provisional application No. 61/794,248, filed on Mar. 15, 2013.

(51) Int. Cl. G06F 3/0488; G06F 3/0481

(52) U.S. Cl. CPC G06F 3/0488; G06F 3/04815
USPC 715/863

(57) ABSTRACT

A method for semantic processing of gestures on a user interface, a method for semantic processing of gestures on a user interface using remote resources, and a device incorporating the method as a novel user interface paradigm. User gestural input is sampled, analyzed, and interpreted while input is still occurring, and a change in user intent effects an action.

### CROSS-REFERENCE TO RELATED APPLICATIONS

This is a non-provisional application of the provisional application having Ser. No. 61/794,248 filed on Mar. 15, 2013, which is based on provisional application Ser. No. 61/700,706 filed on Sep. 13, 2012. The disclosures of each of these provisional applications are incorporated in their entirety by reference.

### BACKGROUND

Gesture-based user interface paradigms have recently become more popular due to the explosion of a mobile smartphone market using almost exclusively capacitive touch screens for touch input. The booming smartphone market has also seen an increase in the use of speech recognition techniques, including the use of semantic processors to perform natural language processing and determine a user's actual intent in uttering a command instead of relying on pre-determined settings by the operating system.

There is constantly a need for new, intuitive interfaces for touch screens and smartphones. Capacitive touch screens are becoming more affordable, and smartphone designs almost entirely rely on a capacitive touch screen instead of resistive touch screens input technologies. These capacitive touch screens now make up a large percentage of the market.

Semantic interpretation has grown quickly, but largely in speech recognition. Apple® Siri™, for example, has been a prominent use of a semantic processor in speech recognition. Markov Chains are also frequently used in speech recognition by providing mathematical weights to frequently-used phonemes and morphemes. This helps speech recognition because human speech contains a series of phonemes and morphemes which are realized by similar, but not audially equivalent, utterances. A learning Markov Chain weights phonemes and morphemes based on the frequency of their use, which helps create a discrete statistical system for determining the nature of a phoneme or morpheme based on novel input.

Gesture interpretation in the prior art is rudimentary. Generally, a gesture is pre-defined and performed on a “hot” context area. Based on the start-point and end-point, as well as any identified curve apogees and perigees, a user's input may be compared to the defined gesture, and, if it matches, an action may be performed. Other gesture interpretation methods exist, but they take a similar approach from the general paradigm of looking up a completed gesture against a database of pre-defined gestures. These interpretations of gestures are limited to interface being used. It is often not the user determining meaning of the gestures but the operating system that controls what gestures can be used to create which actions. Third-party and user defined gestures are not allowed in these systems. A user must use the pre-determined set of gestures which often are generally broad applications. For example in some systems, pressing an icon will allow the user to delete the icon. That interpretation will apply to all icons the same way without a choice or menu to perform other actions.

By applying semantic interpretation techniques to gesture input, a number of advantages over the prior art become apparent. The computational analysis of the user's input makes the input more useful, because the user's intent can be more easily inferred by factoring in all of the data and allowing the semantic processor to filter out what is irrelevant. By applying artificial intelligence techniques, the semantic processor can acclimate itself to a particular user's input, so instead of making the user work harder to make their gestures look proper, the system can “meet halfway” and decide what the user is actually trying to do.

In this way, very intuitive user interfaces can be created, such as a 3D projected or stereoscopically displayed environment where the semantic interpretation of the user's touch allows the user to browse through various context areas, to perform actions instantly on items found through the use of an expressed gesture intent, as determined by the semantic processor. For example, a composite layer may compress or expand in response to a change in pressure of the user's touch. Also, the system can accept new gestures from third-parties or users instead of being limited to the pre-set gestures by the manufacturer.

### SUMMARY OF THE INVENTION

The present invention solves the problem by creating a user interface which is broad and dynamic. The interface intelligently interprets common gestures used on user interfaces in portable devices and allows non-manufacturer parties to create new gestures to be used in conjunction with each program.

The invention relates to a method for semantic processing of gestures on a user interface comprising receiving an instruction on a user interface, identifying a position of the received instruction on the user interface, correlating the identified position to a content area, the content area including information and content area metadata associated therewith, registering additional instructions at the identified position of the received instruction on the user interface, transforming the registered additional instructions to a semantic instruction, the semantic instruction comprising a semantic interpretation of the registered additional instructions, the semantic interpretation being based on at least one or more of the following factors: registration times of the registered additional instructions, the content area, content area information, content area metadata, and a duration of the registered additional instructions, executing a set of actions as a function of the semantic instruction, and providing a result in response to the executed set of actions. Identifying may comprise identifying the position of the received instruction on a display. Transforming may comprise collecting information relating to at least one of the following from a remote information source: registered additional instructions and the received instructions.

The invention further relates to a method for semantic processing of gestures on a user interface of a device comprising receiving an instruction on a user interface of a device, identifying a position of the received instruction on the user interface, correlating the identified position to a content area, the content area including content area information and content area metadata associated therewith, registering additional instructions at the identified position of the received instruction on the user interface, transforming the registered additional instructions to a semantic instruction, the semantic instruction comprising a semantic interpretation of the registered additional instructions, the semantic interpretation being based on at least one or more of the following factors: registration times of the registered additional instructions, the content area, content area information, content area metadata, and a duration of the registered additional instructions, sending a request to a remote source to process the semantic instruction, receiving a response from the remote source, and providing the received response.

The invention further relates to a system for semantic processing of gestures on a user interface comprising a display for receiving an instruction from a user, a user interface for identifying a position of the received instruction on the display, a memory for storing data relating to one or more content areas, the user interface rendering the one or more content areas on the display, a processor configured for correlating the identified position to one or more content areas, the content area including content area information and content area metadata associated therewith, the user interface further registering additional instructions at the identified position of the received instruction on the user interface, the processor being configured for transforming the registered additional instructions to a semantic instruction, the semantic instruction comprising an interpretation of the registered additional instructions based on at least one or more of the following factors: registration times of the registered additional instructions, the content area, the content area information and content area metadata, and a duration of the registered additional instructions, wherein the processor executes a set of actions as a function of the semantic instruction, and wherein the user interface provides a result in response to the executed set of actions on the display. The display, the user interface, the memory and the processor may comprise a hand-held device. The display may comprise a capacitive touch screen overlay.

The invention further relates to a computer-implemented method for processing event inputs using a touch-sensing device, in a device with one or more processors, memory, and a touch-sensitive surface or a touch-sensitive display, comprising: displaying graphical user interface objects, detecting a finger touching the touch-sensing device, calculating the size of a first surface area of contact of a user's finger on the touch-sensitive display, calculating the size of a second surface area of contact of the user's finger on the touch-sensitive surface or the touch-sensitive display, the second pressure area spatially overlapping some of the first pressure area sense circuits such that at least one sense circuit is shared between the first and second pressure area, determining the surface area change of the contact of a user's finger upon the touch-sensitive surface or the touch-sensitive display in response to the finger's changing pressure on the touch-sensing surface or the touch-sensing display, executing an action from a list of items displayed on a touch-sensitive display in response to the user's finger pressure change, the second item being non-equivalent to the first item, the list of items being user interface objects, the action being a simulation of the action of the user interface objects projected in a plane having horizontal and vertical dimensions, the action comprising, but not limiting to: scrolling, shuffling, moving, enlarging, scaling, increasing, decreasing, zooming, tracking, panning, tilting, moving-through, rotating, volume increasing, color changing, signal value increasing, view changing, and other pixels' property value changing, the user interface objects being the graphical user interface objects or other applied programming metaphor, accelerating the action in response to an accelerated surface area change, the data for the accelerated surface area change being stable for a respective time interval, the accelerated surface area change being determined by projecting the accelerated change of the surface area of the pressure area or the accelerated movement of the pressure area in a time interval preceding the respective time interval, and in response to detecting the end of the list being reached or leaving the touch-screen display, and additionally the pressure change is still detected on the touch-sensitive surface or the touch-screen display, the list is paused and executes the actions in reverse order until the beginning of the list is displayed and intermittently halts the action in accordance with the user breaking the point of contact with the touch-sensitive surface or the touch-sensitive display for a pre-determined period of time, the list being paused in response to detecting the termination of the gesture, and the list being paused when the pressure area change is not detected for a pre-defined time interval.

### BRIEF DESCRIPTION OF THE DRAWINGS

FIG. 1 is an illustration of a user interface for a device according to one embodiment of the invention.

FIGS. 2-4 are illustrations of user interactions with a user interface for a device according to one embodiment of the invention.

FIG. 5 is an illustration of another user interaction with a user interface for a device according to one embodiment of the invention.

FIG. 6 is a flowchart that illustrates an embodiment of the invention.

FIG. 7 is a block diagram that illustrates a device wherein the processor and display are embedded in a single device.

FIG. 8 is a block diagram that illustrates a device wherein a remote data store and remote processors are configured to receive user instructions through a network interface.

FIG. 9 is an illustration of another user interaction with a user interface for a device according to one embodiment of the invention.

FIG. 10 is a flowchart that illustrates an alternate embodiment of the invention.

FIG. 11 is a flowchart that illustrates another alternate embodiment of the invention.

FIG. 12 is a block diagram illustrating a system according to one embodiment of the invention.

FIG. 13 is a block diagram illustrating a wireless device according to one embodiment of the invention.

Corresponding reference characters indicate corresponding parts throughout the drawings.

### DETAILED DESCRIPTION

The user interface objects may comprise graphical objects, computer-implemented icons, object metaphors, applets, or applications with selectable interactive electronic objects, file windows, frames, and electronic documents, and the electronic graphical objects may comprise computer-implemented frame content and other content of pages, windows or the display. The user interface objects may comprise computer programs. The user interface object contents may comprise frames and objects that may be scrolled, moved, and shuffled. The user interface object content may be an interactive item. The X, Y, and Z may comprise three axes in a Cartesian coordinate system for a three-dimensional space and a Z-axis may comprise a virtual depth into an electronic device display, new portions of frame content portion of page content display, or stationary application windows on the touch screen display.

The action and accelerating the action may be a simulation of a physical device having friction. The method may further comprise reversing a direction of action in response to the action intersecting a virtual boundary corresponding to the end of a list of items. A touch panel may comprise a resistive, capacitive or other sensing medium configured to detect multiple touches or near touches that occur at distinct locations in a plane of the touch panel and to produce distinct electronic signals representative of a location and surface area of the touches on the plane of the touch panel for each of the multiple touches. The user's touch may be on the touch-screen display. The object may be a finger. The second action direction may be opposite the first action direction. Translating in the first action direction prior to reaching an end of the document may have an associated speed of translation that corresponds to a speed of movement of the object. Translating in the action direction may be in accordance with a simulation of an equation of motion having friction. The action in any direction may be a damped motion, thus dampening the motion effect using a dampening coefficient. Changing from translating in the first direction to translating in the sequential direction until the edge of the graphical user interface object is reached may appear to be elastically attached to the edge of the touch screen display or to the edge displayed on the touch screen display. The device may be an electronic communication device.

The invention further relates to a computer-implemented method for processing input events using a touch-sensing device, comprising: at a device with one or more processors, a memory, and a touch-sensitive surface or a touch-sensitive display: displaying page content on a touch screen display, the page content comprising: a frame displaying frame content and other content of the frame, detecting a finger on the touch screen, detecting a pressure change to a finger surface area change, in response to detecting the finger to surface area change: translating the page content, detecting an accelerated surface area change on the touch screen display, in response to detecting a finger accelerated surface area change gesture: translating the frame content, in response to detecting the finger pressure on the touch screen display: halting the translation for a pre-determined period of time, the second detected added finger pressure area overlapping the first pressure area; the page content including the displayed portion of the frame content and other content of the frame, to display a new portion of frame content on the touch screen display, and halting the list translation in response to the termination of the gesture.

The invention further relates to a gesture-aware device, comprising: a touch-sensing display for displaying graphical user interface objects, one or more processors, memory, a touch-sensing surface, the touch-sensitive surface being configured to determine a surface area change in response to the finger's changing pressure on the touch-sensing device, a controller controlling graphical user interface objects when the event input indicates a first pressure area of a user's finger on the touch-sensitive display in response to the finger's changing pressure on the touch-sensing device, controls a second level of graphical user interface objects when the even input indicates a next pressure area of a user's finger on the touch-sensitive display in response to the finger's changing pressure on the touch-sensing device; one or more programs, wherein the one or more programs are stored in the memory and configured to be executed by the one or more processors, the programs including: instructions for displaying a first portion of a frame content, instructions for detecting a pressure area of a user's finger on the touch-sensitive display in response to the finger's first changing pressure on the touch-sensing device, instructions for detecting a pressure area of a user's finger on the touch-sensitive display in response to a finger's next changing pressure on the touch-sensing device, instructions for translating page content, translating the page content to include the displayed portion of the frame content and the other content of the frame, wherein the next displayed frame is a new portion of frame content, in response to detecting the next finger to surface area change gesture translation; instructions for detecting a finger accelerated surface area change gesture translation on the touch screen display; and instructions for translating the frame content to display a new portion of a frame content on the touch screen display, in response to the finger accelerated surface area change gesture, wherein a new portion of a frame content on the touch screen display is the accelerated translation of the other content of the frame. The multifunction device may be a portable computer. The device may be a communication electronic device. The frame content may comprise a user interface objects. The frame content may comprise computer programs. The user interface objects contents may comprise scrollable, shuffle-able or moveable frames or objects. The X, Y, and Z may be the three axes in a Cartesian coordinate system for a three-dimensional space and the Z-axis is the virtual depth into the electronic device display new portions of frame content portion of page content display or stationary application window on the touch screen display.

The invention further relates to a method for a graphical semantic search query processing of gestures on a user interface comprising receiving graphical objects on a user interface in response to a search query, the graphical semantic search query processor responds to a query by interpreting a machine-readable meaning of the pressure area change and executes a procedure by generating objects on the touch screen display, the user reacts to those objects by selecting the object and applies his pressure gesture on the object on the touch screen, the processor reads the pressure gesture area change in the object context area and analyses the semantic database in relation to the properties of the object and the properties of the gesture, the processor learns and interprets the machine-readable meaning of the pressure area change by generating new objects on the touch screen display using three-dimensional navigation objects and the user's response to the objects and the object's predetermined properties, the processor's semantic database generates new semantic objects and displays the objects in response to the semantic search graphical query, forward twists, and backward twists, the processor interprets the machine-readable gesture meaning of the pressure area change by generating new objects on the touch screen display using three-dimensional navigation.

A three-dimensional navigation system may be a simulated three-dimensional interface by projecting shapes with depth using shading on a two-dimensional interface. A three-dimensional navigation system may also be simulated stereoscopically by isolating multiple projections, at least two of which are intended for a pair of human eyes, such that the illusion of depth is created by projecting two images corresponding to viewpoints having parallel facing vectors.

The invention further relates to a networked system implementing part of the method herein disclosed. In particular use cases, it may be desirable to encode the user's input at the client device, to send the user's encoded input using a network adapter to a remote system, to decode the user's encoded input at the remote system, the remote system implementing the portion of the semantic gesture processor directed towards interpreting the received instruction and additional instructions to generate a semantic instruction, encoding the semantic instruction at the remote system, sending the encoded semantic instruction to the client device, decoding the encoded semantic instruction at the client device, and executing the semantic instruction at the client device.

A semantic database may learn from input using any of a group of statistical learning techniques, such as a Markov Chain. A Markov Chain does not “learn” exactly like a human being—rather, it “learns” by accepting sequential inputs and applying mathematical weights to sequential inputs based on the frequency of the input. The weights of the Markov Chain can be used to interpret ambiguous semantic input by giving the semantic processor the approximate identities of previous semantic input, such that the Markov Chain can assist the semantic processor in recognizing a particular semantic command by “weighting” values closer to frequently-used input higher than values farther away from infrequently-used input. Novel input, which is also infrequently used, can be learned by the Markov Chain as the input is repeated, because the Markov Chain will forge new weights as the novel input is repeated.

FIG. 1 is an illustration of a user interface 101 for a device according to one embodiment of the invention.

For example, the user interface 101 may be a touch-sensitive display area of a portable device; it may also be a touch-sensitive display connected remotely to a server having a processor, memory, and input sensor; alternatively the display may not have a touch-sensing means but it may sense touch-like input through the use of an input camera such as a Microsoft® Kinect™ input device positioned relative to the display, through the use of a camera positioned below the surface of a light-diffusing display surface for sensing objects or human body parts touching the display surface, through the use of a photoresistor array configured to detect a user's input above the display surface, or alternatively through the use of one or more proximity sensors configured to approximate the position of a user's input.

Continuing to refer to FIG. 1, the user interface includes context areas 103 and 105 which are adapted to trigger a semantic gesture interpretation algorithm (not shown) when touched. The context areas may be icons; they may also be “buttons” corresponding to a pre-defined class of actions; they may also be areas containing types of data, such as telephone numbers, e-mail addresses, web addresses, mailing addresses, latitude-longitude pairs, dates and times with or without event context, and any data the device is capable of performing an action in response to user input. The context areas are not limited by location and can be found anywhere on the user interface

Referring now to FIG. 2, a user's touch 107 begins by pressing lightly on one of the context areas 103. The touch 107 is sampled and an instruction is generated from that sample by the semantic gesture interpretation algorithm, which then performs an associated action 109. Additionally, the semantic gesture interpretation algorithm may sample additional contextual information such as but not limited to hardware location, hardware orientation, hardware acceleration, Near-Field Communication (NFC) events, Radio Frequency ID (RFID) events, Bluetooth™ Low Energy (BLE) events, and fine positioning using optical triangulation such as in a Nintendo® Wii Remote™ or Microsoft® Kinect™, and metadata provided by third-party creators of applications. The associated action 109 can vary depending on the type of context area 103 and the additional contextual information. For example, the associated action 109 can represent making a call or adding a contact number or texting a message. The specific associated action 109 will depend on the chosen algorithm.

Referring now to FIG. 3, as the user's touch 107 increases in pressure, an instruction is generated by the semantic gesture interpretation algorithm, which performs another associated action 111, which may be another action or it may be the same action continued or performed again or alternatively it could be a different action. The semantic gesture interpretation algorithm may sample the change in area in a gesture such as a swipe or drag (see FIG. 4).

Referring now to FIG. 4, as the user's touch 107 changes position, the semantic gesture interpretation algorithm suggests yet another associated action 113. The change in position may also be any other sampleable data.

Referring now to FIG. 5, the mobile phone device 213 has a display 215 with context areas 217 219 in a three-dimensional projected or stereoscopic user interface which uses a semantic gesture processor to read the user's touch 221. The mobile phone device may also have a traditional user interface but respond to touch using the semantic gesture processor.

Referring now to FIG. 6, the flowchart illustrates the method in which the interface analyses a gesture. After receiving an instruction on the user interface through a gesture 602, the system identifies the position of the received instruction in relation to the user interface 604. The system then correlated the position to a content area 606 and registers additional instructions at the identified position on the user interface 608. The data is then transformed to a specific semantic instruction 610 and a set of actions are executed 612 as a response to provide the desired result 614 from the original gesture.

In one embodiment, the desired result 614 may be a combination of visual and audio output. For example, the desired result 614 may be a 2-D or 3-D representation of a list. In another embodiment, the desired result 614 may be an audio rendering of the items in the list for the visually impaired.

Referring now to FIG. 7, the process of the flowchart (FIG. 6) is shown as it relates to the hardware 700. Once a gesture is made through the user interface 704 on the display 702, the processor 708 will correlate the position on the user interface 704 to different content areas 712-1, 712-2, 712-3 through databases in the memory banks 710. Once the correct content area is found, the processor will create the semantic instruction 610 (FIG. 6) and execute the proper result 612.

FIG. 8 is a block diagram 800 that illustrates a device wherein a remote data store and remote processors are configured to receive user instructions through a network interface. When the content areas are not found on the memory devices, the system will need to connect to an outside network interface 814 to collect the appropriate data needed to form the correct semantic instruction. The remote network interface 814 will have its own set of processors 818 and memory data storage 816 to perform a similar process to the local processor 806 and memory 808.

Referring now to FIG. 9, the graphical semantic search query processor responds to a query by interpreting a machine-readable meaning of the pressure area change and executing generation of objects 930 on the touch screen 910. The user reacts 970 to objects selecting the object 930 applying a pressure gesture 950 960 on or towards the object. Exemplary arrows 950 960 depict the pressure change combined with side, forward, and backward twists. The processor reads the pressure area change gesture change at the gesture area and analyses the semantic database data in relation to the object predetermined properties. The processor's semantic database generates new semantic objects 920 on the touch screen display in response to the semantic search graphical query.

Referring now to FIG. 10, the flowchart illustrates an alternate embodiment in which the interface analyses a gesture. The touch screen displays a plurality of graphical user interface objects 1010. The system then detects a change in the pressure gesture area 1120. This is typically in the form of the user pressing the touch screen. The processor calculates the pressure chance and direction area change 1030 to see if the gesture is more than just a press. The processor analyzes object identifiers and computes relationships to understand context using the machine-readable associated meaning 1040. Depending on the results of whether the pressure is changed 1065, a semantic database generates other objects 1070 or the system attempts to detect the gesture 1020 again. If the semantic database generates other objects 1070, the system then looks to see if a news gesture is being made for a different object 1085. If not, the list is paused until a new gesture occurs.

Referring now to FIG. 11, the flowchart illustrates another alternate embodiment in which the interface analyses a gesture. The semantic database generates page content on the display screen including a frame displaying a portion of objects and another frame displaying the other portion content of the objects 1110. The system then attempts to detect a finger press on the touch screen display 1120. In response to detecting the finger pressure to surface area change gesture translation, the system displays a new portion of frame content in context to the pressure gesture meaning translation using machine-readable meaning associated with the data 1130. The system then detects a finger accelerated surface area change gesture translation meaning on the touch screen display objects 1140. This will help determine pinch or swipe gestures that are not static to one area. In response to detecting the finger accelerated surface area change gesture translation meaning, there is an accelerated translation of the other content of the frame generated by the device semantic database in response to predetermined properties and machine-readable meaning interpreter 1150. In response to detecting the finger pressure being paused for a pre-determined period of time and the next added finger pressure area being overlapped with the first pressure area, the next frame content is displayed 1160.

Referring now to FIG. 12, the exemplary implementation 1200 is a system 1207 contains a processor 1209 and a memory 1211 which may communicate by way of intermediaries along the Integrated Systems Architecture Bus (ISA Bus) 1213 or alternatively along a type of Front-Side Bus (FSB). The processor may poll the input/output device 1215 for user input data or alternatively the input/output device may receive user input by way of an interrupt. The user input data is processed according to the method herein disclosed and a resultant semantic interpretation triggers an action. The action may be a stretching, zooming, progression throughout a list, triggering a program with arguments related to the resultant semantic interpretation, moving throughout 3 or more 2-D projected or 3-D stereoscopic dimensions in a user interface, or other automated actions using available data. In order to provide a more responsive and data-rich semantic interpretation, the system may have a network adapter 1219 configured to communicate with a network adapter connected to a remote system which implements all or part of the semantic gesture interpretation algorithm on a processor and a memory. The remote system may have one or more computer-readable media configured to store and return processed semantic gesture interpretation data.

Referring now to FIG. 13, the exemplary implementation is a mobile computer device or tablet 1303 containing a touch-sensitive display 1300, a processor, a memory, and one or more network adapters. As in FIG. 12, the user input data is processed according to the method herein disclosed and performs actions in response to the semantic gesture interpretation algorithm's interpretation of the user's input. The mobile computer device may communicate using one or more network adapters with a remote system which implements all or part of the semantic gesture interpretation algorithm on a processor and a memory. The remote system may have a computer readable media configured as in FIG. 12.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above apparatuses and methods without departing from the scope of the invention, it is intended that all matter contained in the above description and shown in the accompanying drawings shall be interpreted as illustrative and not in a limiting sense.

1: A method for semantic processing of gestures on a user interface comprising:
receiving an instruction on a user interface;
identifying a position of the received instruction on the user interface;
correlating the identified position to a content area, the content area including content area information and content area metadata associated therewith;
registering additional instructions at the identified position of the received instruction on the user interface;
transforming the registered additional instructions to a semantic instruction, the semantic instruction comprising a semantic interpretation of the registered additional instructions, the semantic interpretation being based on at least one or more of the following data: registration times of the registered additional instructions, the content area, content area information, content area metadata, and a duration of the registered additional instructions;
executing a set of actions as a function of the semantic instruction; and
providing a result in response to the executed set of actions.

2: The method according to claim 1, wherein identifying comprises identifying the position of the received instruction on a display.

3: The method according to claim 1, wherein transforming comprises collecting information relating to at least one of the following from a remote information source: the registered additional instructions and the received instructions.

4: The method according to claim 1, wherein identifying comprises identifying the position of the received instruction according to at least two scalar values corresponding to dimensional axes in Euclidean space.

5: The method according to claim 4, wherein the position of the received instruction further comprises at least one vector value corresponding to at least one of the following: a change in position, a change in velocity, and a force.

6: The method according to claim 1, wherein providing a result further comprises:
correlating the additional received instructions and the generated semantic instructions in a database; and
generating numerical weights for the registered additional instructions based on one or more of the following: a frequency of occurrence, a numerical average of substantially all occurrences, a maximum numerical occurrence, a minimum numerical occurrence, and one or more statistical deviation from the numerical average of substantially all occurrences.

7: The method according to claim 6, wherein transforming the registered additional instructions into the semantic instruction further comprises:
increasing error tolerance by mathematically weighting the data of the registered additional instructions based on the numerical weights for registered additional instructions.

8: The method according to claim 1, wherein receiving the instruction on a user interface comprises reading the position of a touch on a touch surface or a touch screen display.

9: The method according to claim 1, wherein receiving an instruction on a user interface comprises reading a position of a finger of a user above or on a surface or a display.

10: A system for semantic processing of gestures on a user interface comprising:
a surface or a display for receiving an instruction from a user;
a user interface for identifying a position of the received instruction on the surface or the display;
a memory for storing data relating to one or more content areas;
the user interface rendering the one or more content areas on the surface or the display;
a processor configured for correlating the identified position to the one or more content areas, the one or more content areas including content area information and content area metadata associated therewith;
the user interface registering additional instructions at the identified position of the received instruction on the user interface;
the processor being configured for transforming the registered additional instructions to a semantic instruction, the semantic instruction comprising an interpretation of the registered additional instructions based on at least one or more of the following factors: registration times of the registered additional instructions, the content area, the content area information and content area metadata, and a duration of the registered additional instructions;
wherein the processor executes a set of actions as a function of the semantic instruction; and
wherein the user interface provides a result in response to the executed set of actions on the surface or the display.

11: The system of claim 10, wherein the surface or the display, the user interface, the memory and the processor comprise a hand-held device.

12: The system of claim 10, wherein the surface or the display comprises a capacitive touch surface or a screen overlay.

13: A device configured to process gestures on a user interface comprising:
a surface or a display for receiving an instruction from the user;
a user interface for identifying the position of a received instruction on the surface or the display;
a memory for storing data relating to one or more content areas;
the user interface rendering the one or more content areas on the surface or the display;
a processor configured for correlating the identified position to the one or more content areas;
the one or more content areas including content area information and content area metadata associated therewith;
the user interface registering additional instructions at the identified position of the received instruction on the user interface;
the processor being configured for transforming the registered additional instructions to a semantic instruction, the semantic instruction comprising an interpretation of the registered additional instructions based on at least one or more of the following factors: registration times of the registered additional instructions, the content area, the content area information and content area metadata, and a duration of the registered additional instructions;
wherein the processor executes a set of actions as a function of the semantic instruction; and
wherein the user interface provides a result in response to the executed set of actions on the surface or the display.

14: The device of claim 13, further comprising:
at least one network interface configured to communicate with a remote processor;
the remote processor being configured for transforming the registered additional instructions to a semantic instruction, the semantic instruction comprising an interpretation of the registered additional instructions based on at least one or more of the following factors: registration times of the registered additional instructions, the content area, the content area information and content area metadata, and a duration of the registered additional instructions; and
the network interface being configured to receive a semantic instruction from the remote processor for execution on the processor on the device.

15: The device of claim 13 further comprising:
a three-dimensional content area;
the three-dimensional content area being displayable as a two-dimensional projection on a flat display;
the three-dimensional content area being displayable as two stereoscopic projections on a flat display;
correlating the position of a received instruction to the three-dimensional content area comprises: sampling a position from two perpendicular axes coplanar with the display and correlating the position with one or more of the following: a third sampled axis normal to the display, a pressure, a velocity, an acceleration, a force, content area information, content area metadata, temporal parameters, and registered additional instructions.

16: A networked system for semantic processing of gestures on a user interface comprising:
a network interface configured to communicate with a remote client;
the remote client having a remote display, a remote user interface, a remote processor, and a remote memory;
the network interface being configured to receive encoded instructions;
the encoded instructions comprising one or more received instructions at the remote display;
a memory for storing data related to one or more content areas;
a processor being configured for decoding the encoded instructions to produce registered instructions;
the processor being configured for transforming the registered instructions to a semantic instruction, the semantic instruction comprising an interpretation of the registered instructions based on at least one or more of the following factors: registration times of the registered instructions, the content area, the content area information and content area metadata, and a duration of the registered instructions;
the processor being configured for encoding the semantic instruction to produce an encoded semantic instruction; and
the network interface being configured to send encoded semantic instructions to a remote device.

17: The networked system of claim 16 further comprising:
a database for storing statistical information related to the input and output of the transformation of the registered instructions to a semantic instruction; and
the processor being configured to filter information from the database to produce filtered statistics based on one or more of the following criteria: the identity of the user, characteristics of the input device, characteristics of the display, characteristics of the user interface, the user's location, and metadata associated with the semantic instruction.

18: The networked system of claim 16 further comprising:
The processor being configured for transforming the registered instructions to a semantic instruction, the semantic instruction comprising an interpretation of the registered instructions based on at least one or more of the following factors: registration times of the registered instructions, the content area, the content area information and content area metadata, a duration of the registered instructions, and filtered statistics from the database.

19: A method for semantic processing of gestures on a user interface of a device comprising:
receiving an instruction on a user interface of a device;
identifying a position of the received instruction on the user interface;
correlating the identified position to a content area, the content area including content area information and content area metadata associated therewith;
registering additional instructions at the identified position of the received instruction on the user interface;
transforming the registered additional instructions to a semantic instruction, the semantic instruction comprising a semantic interpretation of the registered additional instructions, the semantic interpretation being based on at least one or more of the following factors: registration times of the registered additional instructions, the content area, content area information, content area metadata, and a duration of the registered additional instructions;
sending a request to a remote source to process the semantic instruction;
receiving a response from the remote source; and
providing the received response.
